(19) United States
(12) Patent Application Publication
(10) Pub. No.: US 2011/0182471 A1
(43) Pub. Date: Jul. 28, 2011

(54) HANDLING INFORMATION FLOW IN PRINTED TEXT PROCESSING

(75) Inventors: Leon Reznik, Sudbury, MA (US); Levy Ulanovsky, Sudbury, MA (US); Helen Reznik, Sudbury, MA (US)

(73) Assignee: ABISee, Inc., Acton, MA (US)

(21) Appl. No.: 12/952,447

(22) Filed: Nov. 23, 2010

Related U.S. Application Data
(60) Provisional application No. 61/283,168, filed on Nov. 30, 2009.

(51) Int. Cl. G06K 9/00; G06K 9/20

(52) U.S. Cl. 382/103; 382/321

(57) ABSTRACT

Systems, methods and computer-readable media for processing an image are disclosed. The system comprises a processor, an image capturing unit in communication with the processor, an inspection surface positioned so that at least a portion of the inspection surface is within a field of view (FOV) of the image capturing unit, and an output device. The system has software that monitors the FOV of the image capturing unit for at least one event. The inspection surface is capable of supporting an object of interest. The image capturing unit is in a video mode while the software is monitoring for the at least one event

### CROSS-REFERENCE TO RELATED APPLICATION

The present application claims priority to Provisional U.S. Application No. 61/283,168 filed Nov. 30, 2009 and entitled “Arranging Text under a Camera and Handling Information Flow,” which is incorporated in its entirety.

### FIELD OF THE INVENTION

The present invention relates generally to operating a digital camera, and, more particularly, to input and output control methods that make the process more user friendly and raise the quality of output.

### BACKGROUND OF THE INVENTION

Physical disabilities, reading problems, language ineptitudes or other limitations often make it difficult, tedious or impossible for some people to read printed matter. Among such people are those with low or no vision and dyslexic readers. People insufficiently fluent in the language of the printed matter often have similar difficulties. Various technologies exist for assisting such readers. Some devices ultimately convert text to speech. Some other devices magnify the text image, often using a video or still camera. Yet other devices improve contrast, reverse color, or facilitate reading in other ways. Language translation software, such as Google-translate, is available. In many cases, instead of, or in addition to a video stream, a still digital photographic image of printed matter needs to be made before further processing.

### SUMMARY OF THE INVENTION

The present invention overcomes the problems and disadvantages associated with current techniques and designs and provides new systems and methods of control of input and output associated with processing text in an image.

One embodiment of the invention is directed to a system for processing an image. The system comprises a processor, an image capturing unit in communication with the processor, an inspection surface positioned so that at least a portion of the inspection surface is within a field of view (FOV) of the image capturing unit and an output device. The system further comprises software executing on the processor that monitors the FOV of the image capturing unit for at least one event. The image capturing unit is in a video mode while the software is monitoring for the at least one event. The inspection surface is capable of supporting an object of interest.

In a preferred embodiment, the software recognizes text in a captured image and converts the text into a computer readable format using OCR (optical character recognition). Preferably, the software directs the image capturing unit to capture an image upon detection of an event.

In a preferred embodiment, the processor is within a housing and an upper surface of the housing is the inspection surface. Preferably, there is at least one marker on the inspection surface and an event is at least one of the blocking of the view of the at least one marker from the image capturing unit, and the appearance of at least one marker within the FOV. In a preferred embodiment, the software directs the image capturing unit to capture an image upon (1) a detection of a marker becoming obscured (in other words disappearing) from the view of the image capturing unit and (2) a subsequent detection of the absence of motion in the FOV of the image capturing unit above a preset limit of motion level for a preset time span.

In a preferred embodiment, an event is a hand gesture of a user within the FOV of the image capturing unit. Preferably, different hand gestures cause the processor to execute different commands. The different commands can be chosen from the group comprising capturing an image, stopping output flow, resuming output flow, rewinding output flow, fast forwarding output flow, pausing output flow, increasing output flow speed, reducing output flow speed, magnifying the output image on the a display, shrinking the output image on a display, and highlighting at least a portion of output image on a display.

In a preferred embodiment, the output device is a display device and text is displayed on the display device and/or the output device is a speaker and text is read aloud via the speaker using text-to-speech conversion software.

Another embodiment of the invention is directed to a computer-readable media containing program instructions for processing an image. The computer-readable media causes a computer to monitor the field of view (FOV) of an image capturing unit for at least one event, capture an image upon detection of an event, and output at least a part of the processed image.

In a preferred embodiment, computer-readable media causes the computer to extract text from a captured image and convert the text into a computer readable format. Preferably, an event is one of at least one marker being obscured from the view of said image capturing unit, and the appearance of at least one marker within the FOV of said image capturing unit. Preferably, the computer-readable media causes the image capturing unit to capture an image upon (1) a detection of a marker becoming obscured from the view of the image capturing unit and (2) the subsequent detection of the absence of motion in the

FOV of the image capturing unit above a preset limit of motion level for a preset time span.

In a preferred embodiment, an event is a hand gesture of the user within the FOV of the image capturing unit. Preferably, different hand gestures cause the computer to execute different commands. The different command can be chosen from the group comprising capturing an image, stopping output flow, resuming output flow, rewinding output flow, fast forwarding output flow, pausing output flow, increasing output flow speed, reducing output flow speed, magnifying the output image on the a display, shrinking the output image on a display, and highlighting at least a portion of output on a display. In a preferred embodiment, the output is text displayed on a display device and/or is text read aloud via a speaker.

Another embodiment of the invention is directed to a method of processing an image. The method comprises the steps of monitoring the field of view (FOV) of an image capturing unit for at least one event, capturing an image upon detection of an event, processing said image into a user consumable format, and outputting at least a part of the processed image.

In a preferred embodiment, the method further comprises extracting text from a captured image and converting the text into a computer readable format. Preferably, an event is one of at least one marker being obscured from the view of the image capturing unit, and the appearance of the at least one marker within the FOV of said image capturing unit.

In a preferred embodiment, the method further comprises capturing an image upon (1) a detection of a marker becoming obscured from the view of the image capturing unit and (2) a subsequent detection of the absence of motion in the FOV of the image capturing unit above a preset limit of motion level for a preset time span.

In a preferred embodiment, an event is a hand gesture of the user within the FOV of the image capturing unit. Preferably, different hand gestures cause a computer to execute different commands. The different command can be chosen from the group comprising capturing an image, stopping output flow, starting output flow, rewinding output flow, fast forwarding output flow, pausing output flow, increasing output flow speed, reducing output flow speed, magnifying the output image on the a display, shrinking the output image on a display, and highlighting at least a portion of output on a display.

Preferably, the user consumable format is text displayed on a display device and/or is text read aloud via a speaker.

Another embodiment of the invention is directed to a system for processing an image. The system comprises a processor within a housing, an image capturing unit in communication with the processor, an inspection surface, and an output device. The system also comprises software executing on the processor, wherein the software monitors the FOV of the image capturing unit for at least one event and recognizes text in a captured image and converts the text into a computer readable format using OCR (optical character recognition). The image capturing unit is positioned so that at least a portion of the inspection surface is within a field of view (FOV) of the image capturing unit. In the preferred embodiment, the upper surface of the housing is the inspection surface.

Other embodiments and advantages of the invention are set forth in part in the description, which follows, and in part, may be obvious from this description, or may be learned from the practice of the invention.

### DESCRIPTION OF THE DRAWINGS

The invention is described in greater detail by way of example only and with reference to the attached drawings, in which:

FIG. 1 illustrates an example component embodiment;

FIG. 2 illustrates an example system embodiment;

FIG. 3 illustrates a method embodiment; and

FIG. 4 illustrates an example of a two-column text page to be scanned by the device of the invention.

### DESCRIPTION OF THE PREFERRED EMBODIMENT

As embodied and broadly described herein, the disclosures herein provide detailed embodiments of the invention. However, the disclosed embodiments are merely exemplary of the invention that may be embodied in various and alternative forms. Therefore, there is no intent that specific structural and functional details should be limiting, but rather the intention is that they provide a basis for the claims and as a representative basis for teaching one skilled in the art to variously employ the present invention.

One object of the present invention is to provide user friendly control over the flow of information. This includes methods and systems for control at the input stage, such as triggering a digital camera to take a picture (capture a digital image) or changing the optical zoom of the camera. This also includes methods and devices for control at the output stage, whether audio, visual, Braille or other format. Such control can be, for example, changing digital zoom (e.g. magnification on the screen), color, contrast and/or other output characteristics, as well as the flow of the output information stream. Such flow of the output stream can be the flow of the output from OCR (optical character recognition). Examples of such OCR output are 1) speech generated from text, 2) OCR-processed magnified text on a screen, and/or 3) Braille-code streaming into a refreshable Braille display.

With reference to FIG. 1, an exemplary system includes at least one general-purpose computing device 100, including a processing unit (CPU) 120 and a system bus 110 that couples various system components including the system memory such as read only memory (ROM) 140 and random access memory (RAM) 150 to the processing unit 120. Other system memory 130 may be available for use as well. The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 may further include storage devices such as a hard disk drive 160, a magnetic disk drive, an optical disk drive, tape drive or the like. The storage device 160 is connected to the system bus 110 by a drive interface. The drives and the associated computer readable media provide nonvolatile storage of computer readable instructions, data structures, program modules and other data for the computing device 100. The basic components are known to those of skill in the art and appropriate variations are contemplated depending on the type of device, such as whether the device is a small, handheld computing device, a desktop computer, a computer server, or a wireless device.

Although the exemplary environment described herein employs flash memory cards, it should be appreciated by those skilled in the art that other types of computer readable media which can store data that are accessible by a computer, such as magnetic cassettes, hard disks, digital versatile disks, cartridges, random access memories (RAMs), read only memory (ROM), a cable or wireless signal containing a bit stream and the like, may also be used in the exemplary operating environment.

Unless specified otherwise, for the purpose of the present invention, an optical input device 190 is implied to be a camera (aka image capturing unit) in either video or still mode. However, any number of input mechanisms, external drives, devices connected to ports, USB devices, such as a microphone for speech, touch-sensitive screen for gesture or graphical input, keyboard, buttons, camera, mouse, motion input, speech and so forth can be present in the system. The output device 170 can be one or more of a number of output mechanisms known to those of skill in the art, for example, printers, monitors, projectors, speakers, and plotters.

In some instances, multimodal systems enable a user to provide multiple types of input to communicate with the computing device 100. The communications interface 180 generally governs and manages the input and system output. There is no restriction on the invention operating on any particular hardware arrangement and therefore the basic features here may easily be substituted for improved hardware or firmware arrangements as they are developed.

For clarity of explanation, the illustrative system embodiment is presented as comprising individual functional blocks (including functional blocks labeled as a “processor”). The functions these blocks represent may be provided through the use of either shared or dedicated hardware, including, but not limited to, hardware capable of executing software. For example the functions of one or more processors presented in FIG. 1 may be provided by a single shared processor or multiple processors. (Use of the term “processor” should not be construed to refer exclusively to hardware capable of executing software.) Illustrative embodiments may comprise microprocessor and/or digital signal processor (DSP) hardware, read-only memory (ROM) for storing software performing the operations discussed below, and random access memory (RAM) for storing results. Very large scale integration (VLSI) hardware embodiments, as well as custom VLSI circuitry in combination with a general purpose DSP circuit, may also be provided.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

The system of the invention preferably comprises the following hardware devices: a high resolution camera (e.g. a CCD or CMOS camera) with a large field of view (FOV), a structure to support the camera (to keep it positioned), a computer equipped with a microprocessor (CPU) as well as memory of various types, an optional monitor (display) that provides a screen, and/or a speaker.

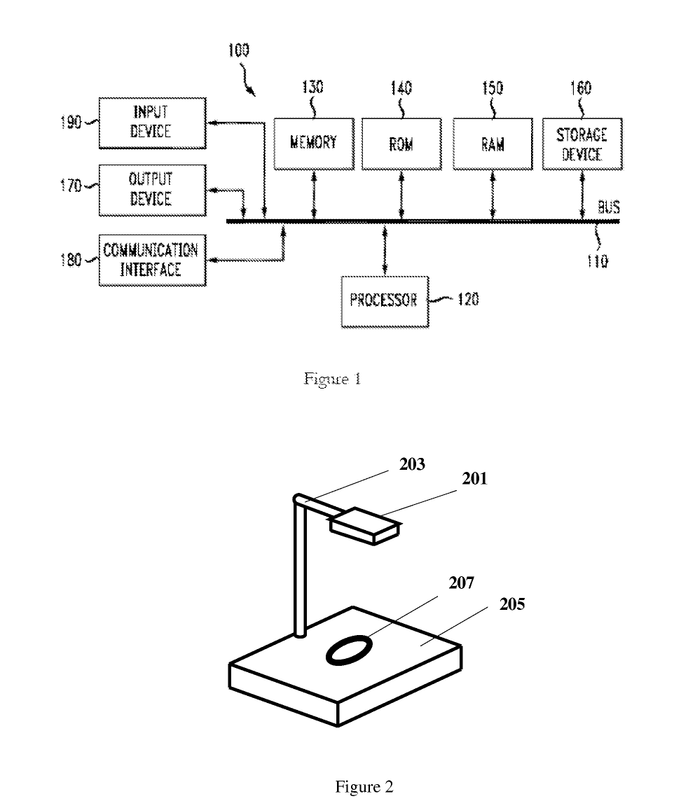

FIG. 2 schematically illustrates the structural setup of the device. A camera 201 is mounted on a support 203 at a fixed distance, preferably between 20 cm and 50 cm, from inspection surface 205. A viewed object, which is usually a page of printed material or an open book, can be placed on inspection surface 205 within the field of view of camera 201. The camera lens is facing toward surface 205, where the viewed object is to be located. If neither optical zoom nor digital magnification are tunable, the field of view (FOV) of the camera is preferably fixed to be large enough to cover a full printed page placed on surface 205. The camera resolution is preferably about 3 Megapixels or higher. This resolution allows the camera to resolve small details of the full captured page including small fonts, fine print and details of images.

In a specific example, a camera sensor of 5 Megapixels is used. The camera is preferably fixed at about 40 cm above the inspection surface on which an object of interest is placed. The lens field of view is preferably 50°. That covers an 8½ by 11″ page plus about 15% margins. The aperture of the lens is preferably small relative to the focal length of the lens, e.g. the diameter of the aperture is three times smaller than the focal length. The small aperture enables the camera to resolve details over a range of distances, so that it can image a single sheet of paper as well as a sheet of paper on a stack of sheets (for example a thick book). LEDs or another source of light, whether visible or infrared, may be used to illuminate the observed object.

Camera 201 feeds information to a digital information processor referred to as a CPU. In FIG. 2, the CPU is located in a box under inspection surface 205. Thus, the top of the box serves as inspection surface 205. Preferably the top surface of the box is 8½ by 11 inches, so that a blind user can feel the edges framing the area (inspection surface 205) for placing printed material. The CPU is capable of performing image processing. The CPU is also capable of controlling camera 201. Examples of commands that control the camera are: take a still picture (capture a digital image), change the speed of video stream (frames per second, FPS) and change optical zoom.

Camera 201 produces either a Monochrome or a raw Bayer image. If a Bayer image is produced, then computer (CPU) converts the Bayer image to RGB. The standard color conversion is used in video mode. Conversion to grayscale may be used in still images. The grayscale conversion is optimized such that the sharpest detail is extracted from the Bayer data.

The system can work and present output in various modes:

### 1. Video Mode.

In Video Mode, the CPU receives image frames from the camera in real time. If a monitor screen is included in the system it may display those images in real time. If optical zoom and/or digital magnification is tunable, a sighted user can adjust them in Video Mode and watch the object of interest to a) inspect the magnified video image, i.e. read magnified text, and/or b) best fit the object of interest into the FOV (field of view) of the camera for taking a still picture of the object. The user can shift the object for either purpose.

### 2. Capture Mode.

Capture Mode, or Still Mode, allows the user to freeze the preview at the current frame and to capture a digitized image of the object into the computer memory, i.e. to take a picture. Here we assume that the object is a printed page of text. In this mode, a sighted user can view the captured image as a whole. One purpose of this mode of viewing is to verify that the whole text of interest (page, column) is within the captured image. Another is to verify that no, or not too much of, other text (parts of adjacent pages or columns) or picture is captured. If the captured image is found inadequate in this sense, the user can go back to Video Mode, move the object, change the optical zoom, and/or digital magnification and capture an image again.

### 3. Optical Character Recognition (OCR).

OCR is well known in the art. OCR software converts an image file into a text file. Once OCR has been performed, its output can be presented to a user in various formats, for example speech (by text-to-speech software), Braille or artificial font text on the screen.

### 4. Output Presentation (to User).

In the process of the presentation of text output to a user, the user can receive the text output in such formats as speech, Braille or magnified text on the screen. The flow of the output presentation is preferably under user's control in that, for example, the user can stop or resume this flow at will.

### Example of Image Processing Steps:

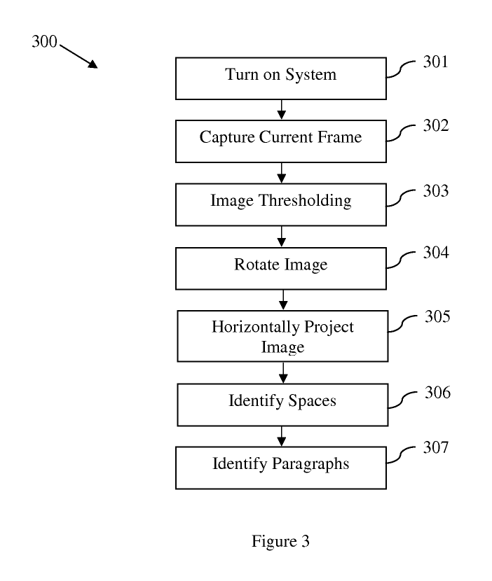

FIG. 3 depicts a flow chart 300 of an example of some of image processing steps. At step 301 the system is turned on. At step 302, the system is preferably in Capture Mode and the CPU captures the current frame (e.g. an image of a page of text) into the computer memory. The CPU performs image thresholding at step 303 and converts the image to one-bit color (two-color image, e.g. black and white). At step 304, the image is rotated to optimize the subsequent line projection result. The rotated image, or part of it, is then horizontally projected (i.e. sideways), and lines are identified on the projection as peaks separated by valleys (the latter indicating spacings between lines) at step 305. Step 305, starting from rotation, can be repeated to achieve horizontality of the lines.

Spaces between words (or between characters, in a different embodiment) are identified at step 306 by determining the positions of valleys in a vertical projection of line image, one text line at a time. Finding all of the spaces may not be necessary, just a sufficient number of spaces need to be identified to choose new locations for lines breaks to wrap magnified lines on the screen when no OCR has been done.

Paragraph breaks are identified at step 307 by the presence of at least one of the following: i) an unusually wide valley in the horizontal (sideways) projection, ii) an unusually wide valley in the vertical projection at the end of a text line, or/and iii) an unusually wide valley in the vertical projection at the beginning of a text line.

In the captured image, some portions of the text are accepted by the software for further processing, while some portions are rejected. The following is one example.

Rejection of a Column that is Captured in Part:

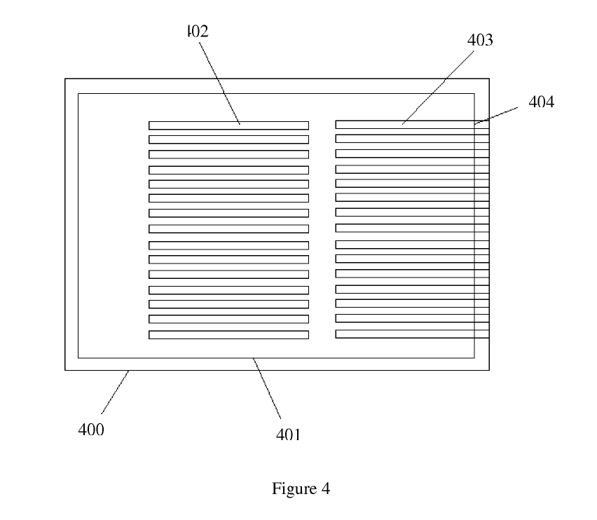

FIG. 4 illustrates an example of a two-column text page to be scanned by the device of the invention. Left column 402 fully fits in frame 401, which is the frame of the captured image. Right column 403 does not fully fit within frame 401, and therefore its text should not be presented to the user, nor be read out loud, nor should the text be printed, nor saved as text. The software seeks lines of text that run off the captured image into the surrounding parts of the field of view 400. Such lines may be considered as unsuitable for being presented to the user.

In embodiments where there is a visual output, options for displaying text on the screen include 1) showing video image of the text in real time, 2) showing the photographed image of the text on the display (monitor, screen) while indicating (e.g., highlighting) the word (or line) being pronounced (read out) to the user, 3) showing the word being pronounced enlarged and optionally scrolling (moving horizontally) across the screen, so that the line that is being read out scrolls (moves horizontally) on the screen, entering on one side and exiting on the other side, and/or 4) a previous option without sound.

In distinguishing “still mode” from “video mode” of the camera, the following should be noted. Still mode is preferably used to take still pictures (capture images) and is usually characterized by a higher resolution compared to video mode. Video mode, also termed “idle mode” is preferably used all the time that the camera is not taking a still picture. For some purposes Video Mode is referred to as Motion-Detector Mode. In video mode the camera preferably works at a frame rate characteristic for video cameras, such as 30 frames per second or the like.

In preferred embodiments, the system uses a motion detector mode. In this mode, a motion-detector is active in software that processes video stream from the camera. In some settings, “motion-detector mode” is synonymous with “Video Mode”. In such settings, Video Mode is essentially opposed to still mode, aka Capture Mode. Usually, a video stream has a lower resolution than a still picture taken with the same camera. This difference enables a higher frame rate in video than in still picture taking. The motion-detector software detects and monitors the level of motion captured by the camera, for example, by measuring the amount of movement in the camera's field of view from frame to frame. In one possible setting, e.g. for scanning a book, if such motion is above a preset limit (i.e. there is motion), the motion detector software continues to monitor the images. If the motion drops and stays below a preset limit for a preset time interval, such level of non-motion triggers the camera to take a still picture. Optionally, before the still picture is taken, the video image is analyzed for the presence of text lines in the image. The outcome of such analysis can affect the decision by the algorithm to take a still picture. After a still picture is taken, an increase of motion above the preset limit for longer than a preset time interval followed by its drop below the preset limit for a preset time triggers taking another still picture. This increase in motion typically happens when the user is turning a page over, while a drop in motion is expected to mean that the page has been turned over and that a picture is to be taken. Optionally, in the motion-detector mode, the brightness of the field of view is monitored, at least at the moment before a still picture is taken. The monitored brightness helps optimize the amount of light to be captured by the camera sensor in the subsequent taking of a still picture, which amount is controlled by what is commonly called “time exposure” or “shutter speed”.

In preferred embodiments, the system can establish the absence of an object of interest under the camera. It is desirable that the camera does not take still pictures when no object of interest is in the field of view of the camera. One way to signal the absence of such object in the field of view of the camera 201, in FIG. 2, is to have a predefined recognizable image 207 associated with inspection surface 205 on which printed matter is normally placed. For example, image 207 can be drawn, painted, engraved, placed as a sticker-label, etc. on inspection surface 205. In FIG. 2, predefined image 207 is symbolized by an oval on inspection surface 205, however any distinct image (also called marker herein) can be used. If nothing blocks the view from camera 201 to such recognizable image 207, the camera recognizes the presence of image 207 in its field of view. This image recognition can be done by measuring correlation between what is currently viewed and what is stored in the memory. In other words, an image file is stored in the memory of the computer, which file contains image 207 as camera 201 normally sees it. This image file is compared by the computer with what camera 201 is currently viewing. Correlation between the two images is measured for the purpose of their comparison and image recognition. This recognition is straightforward if the camera is always kept at essentially the same distance and the same angle to the predefined image on the surface. If image 207 is recognized as currently viewed, this recognition conveys the signal to the camera to stay in the “idle” mode, rather than to take a still picture.

The system can have an audio Indicator of the absence of an object of interest under the camera. An optional audio indicator can signal to the user that the predefined recognizable image, image 207, has appeared in the field of view of camera 201. This signal tells the user that the software assumes that there is no object of interest, such as printed matter, under the camera at this moment. For example, a recording can play the words “Please place a document”, once image 207 has appeared in the view of camera 201.

Another use of the predefined image, image 207 in FIG. 2, is to be used for assessing the lighting conditions. The assessment on the basis of the brightness of the predefined image of a known albedo is preferable to that on the basis of the brightness of the object to be photographed, that generally has an unknown albedo. This assessment can then be used for optimizing the exposure and/or aperture of the camera for taking still pictures of objects of widely varying brightness (albedo) under a range of lighting conditions. The same predefined image, image 207 in FIG. 2, can be used for adjusting white balance too.

The system can signal the presence of printed matter under the camera. For example, covering a predefined recognizable image, e.g. image 207 in FIG. 2, with a sheet of paper, a book, etc. blocks the view of the recognizable image from the sight of the camera. Such a blocking would result in the disappearance of this image from the field of view of the camera. Then, motion detection software monitors the level of motion in the field of view of the camera for taking a still picture when appropriate. As described herein, after the motion has stopped and stayed below a predefined threshold for a predefined time span, the camera captures a still image of the printed matter that has been placed in its field of view. An optional audio sound, such as a shutter sound, can signal to the user that the camera has taken a still shot. The user can then expect that the captured still image is being processed.

In preferred embodiments, the user can give commands by gestures. The printed text converted into magnified text on a monitor (for example as a scrolling line), or into speech, is intended for user's consumption. In the process of such output consumption, the user may wish to have control over the flow of the output text or speech. Specifically, such control may involve giving commands similar to what is called in other consumer players “Stop”, “Play”, “Fast-Forward” and “Rewind” commands. Commands such as “Zoom In”, “Zoom Out” can also be given by gestures, even though they may not be common in other consumer players. When such commands are to be given, the camera is usually in video mode, yet is not monitoring turning pages in book-scanning setting. Thus, the camera can be used to sense a specific motion or an image that signals to the algorithm that the corresponding command should be executed. For example, moving a hand in a specific direction under the camera can signal one of the above commands. Moving a hand in a different direction under the camera can signal a different command. In another example, the field of view of the camera can be arranged to have a horizontal arrow that can be rotated by the user around a vertical axis. The image-processing algorithm can be pre-programmed to sense the motion and/or direction of the arrow. Such a motion can be detected and a change in the direction of the arrow can be identified as a signal. Here we call such a signal a “gesture”. A common software algorithm for the identification of the direction of motion, known as “Optical Flow” algorithm, can be utilized for such gesture recognition.

The interpretation of a gesture can be pre-programmed to depend on the current state of the output flow. For example, gesture interpretation can differ between the states in which 1) the text is being read out (in speech) to the user, 2) the text reading has been stopped, 3) magnified text is being displayed, etc. For example the gesture of moving a hand from right to left is interpreted as the “Stop” (aka “Pause”) command if the output text or speech is flowing. Yet, the same gesture can be interpreted as “Resume” (aka “Play”) if the flow has already stopped.

Moving a hand in other manners can signal additional commands. For example, moving a hand back and forth (e.g. right and left), repeatedly, can signify a command, and repeating this movement a preset number of times within a preset time-frame can signify various additional commands.

Gestures can also be interpreted as commands in modes other than output flow consumption. For example, in Video Mode, a gesture can give a command to change optical zoom or digital magnification. For this purpose, it is desirable to distinguish motion of a hand from other motion, such as motion of printed matter under the camera.

Optionally, the software that processes the video stream can recognize shapes of human fingers or the palm of the hand. With this capability, the software can distinguish motion of the user's hands from motion of the printed matter.

In yet another mode, specifically during scanning of a book, alternating time intervals of motion and no motion can convey [communicate] the process of turning pages, as described herein. Such time intervals of motion and no motion can be considered as gestures too, even if the motion direction is irrelevant for the interpretation of the gesture. Specifically, as a page of a book is being turned, motion is being detected by the motion detector software via the camera. The detected motion may be either that of a hand or that of printed matter. The fact that the page has been turned over and is ready for photographing is detected by the motion detector as the subsequent absence of motion. In practice, if motion (as observed by the detector) has dropped and stayed below a preset level for a preset time interval, the software interprets the drop as the page having been turned over. This triggers taking a picture (photographing, capturing a digital image, a shot) and signaling this event to the user. Before the next shot is taken, the detector should see enough motion again and then a drop in motion for a long enough period of time. In this mode (e.g., book scanning), motion in any direction is being monitored, unlike in specific hand gesture recognition during output consumption, where motion in different directions may mean different commands.

More than one predefined recognizable image can be drawn, painted, engraved, etc., on the surface, such as surface 205 in FIG. 2, on which printed matter is normally placed. Accordingly, covering a subset of those recognizable images can signal different commands. For example, covering a subset of images located around a specific corner of surface 205 in FIG. 2, as viewed from camera 201, may signal a command that is different from a command signaled by covering a subset of images around a different corner of surface 5. Such covering can be achieved by placing printed matter, a hand, or other objects on a subset of images or above it. The resulting commands include the “Stop”, “Play”, “Fast-Forward” and “Rewind” commands, as well as activating the motion-detector mode.

Furthermore, time sequences of covered and uncovered images can be pre-programmed to encode various commands. A large number of commands can be encoded by such time sequences. Moving a hand above the surface of images in a specific manner can signal commands by way of covering and uncovering the images in various order (sequences). For example, moving a hand back and forth (e.g. right and left) can signify a command. Repeating this movement a preset number of times within a preset time-frame can signify various additional commands. In such gesture recognition, the shape of a hand can be used to differentiate such hand gestures from movement of printed matter over the surface. Such shape can be indicated by the silhouette of the set of images covered at any single time. Also, image recognition algorithms can be used for the purpose of recognizing hands, fingers, etc.

A printed page may contain a set of predefined recognizable images. Just as the surface, such as surface 205 in FIG. 2, on which printed matter is normally placed can display recognizable images, a printed page placed on such a surface can display images too. Once a page photograph is stored, its text characters, word sets and other features can be used as recognizable images. Those features can be programmed to be assigned to their coordinates (position) in the field of view of the camera. In other words, the images corresponding to a specific coordinate range are not pre-defined a priori but rather assigned to their position after photographing the page. One use of these page features is giving commands by covering and uncovering these images, e.g. by hand. This includes hand gestures seen as time sequences of covered and uncovered images (and thus their positions). The stored page image can work for this purpose as long as the page remains under the camera with no shift. The presence of the page with no shift is therefore monitored. If the page with no shift is absent, the algorithm searches 1) for the standard predefined images on the surface, such as surface 205 in FIG. 2, on which printed matter is normally placed, and if none is found, 2) for another page or 3) for the same page with a shift. In all three cases the images seen by the camera can serve as a new predefined recognizable image set as described above. For example, moving a hand over such a page can signify various commands depending on the direction of the movement. For another example, covering a specific portion of such a page with a hand can signify a command too.

Other embodiments and uses of the invention will be apparent to those skilled in the art from consideration of the specification and practice of the invention disclosed herein. All references cited herein, including all publications, U.S. and foreign patents and patent applications, are specifically and entirely incorporated by reference. It is intended that the specification and examples be considered exemplary only with the true scope and spirit of the invention indicated by the following claims. Furthermore, the term “comprising of” includes the terms “consisting of” and “consisting essentially of.”

1. A system for processing an image, comprising:
a processor;
an image capturing unit in communication with the processor;
an inspection surface, capable of supporting an object of interest, positioned so that at least a portion of the inspection surface is within a field of view (FOV) of the image capturing unit;
software executing on the processor, wherein the software monitors the FOV of the image capturing unit for at least one event; and
an output device in communication with the processor;
wherein the image capturing unit is in a video mode while the software is monitoring for the at least one event.

2. The system of claim 1, wherein the software recognizes text in a captured image and converts the text into a computer readable format using OCR (optical character recognition).

3. The system of claim 1, wherein the software directs the image capturing unit to capture an image upon detection of an event.

4. The system of claim 1, wherein the processor is within a housing and an upper surface of the housing is the inspection surface.

5. The system of claim 1, wherein there is at least one marker on the inspection surface and an event is at least one of the blocking of the view of the at least one marker from the image capturing unit, and the appearance of at least one marker within the FOV.

6. The system of claim 1, wherein the software directs the image capturing unit to capture an image upon (1) a detection of a marker becoming obscured from the view of the image capturing unit and (2) a subsequent detection of the absence of motion in the FOV of the image capturing unit above a preset limit of motion level for a preset time span.

7. The system of claim 1, wherein an event is a hand gesture of a user within the FOV of the image capturing unit.

8. The system of claim 7, wherein different hand gestures cause the processor to execute different commands.

9. The system of claim 8, wherein the different commands are chosen from the group comprising capturing an image, stopping output flow, resuming output flow, rewinding output flow, fast forwarding output flow, pausing output flow, increasing output flow speed, reducing output flow speed, magnifying the output image on the a display, shrinking the output image on a display, and highlighting at least a portion of output image on a display.

10. The system of claim 1, wherein the output device is a display device and text is displayed on the display device.

11. The system of claim 1, wherein the output device is a speaker and text is read aloud via the speaker by means of text-to-speech conversion software.

12. A computer-readable media containing program instructions for processing an image, that causes a computer to:
monitor the field of view (FOV) of an image capturing unit for at least one event;
capture an image upon detection of an event; and
output at least a part of the processed image.

13. The computer-readable media of claim 12, wherein the computer-readable media causes the computer to extract text from a captured image and convert the text into a computer readable format.

14. The computer-readable media of claim 12, wherein an event is one of at least one marker being obscured from the view of said image capturing unit, and the appearance of at least one marker within the FOV of said image capturing unit.

15. The media of claim 12, wherein the computer-readable media causes the image capturing unit to capture an image upon (1) a detection of a marker becoming obscured from the view of the image capturing unit and (2) the subsequent detection of the absence of motion in the FOV of the image capturing unit above a preset limit of motion level for a preset time span.

16. The computer-readable media of claim 12, wherein an event is a hand gesture of the user within the FOV of the image capturing unit.

17. The computer-readable media of claim 15, wherein different hand gestures cause the computer to execute different commands.

18. The computer-readable media of claim 16, wherein the different command are chosen from the group comprising capturing an image, stopping output flow, resuming output flow, rewinding output flow, fast forwarding output flow, pausing output flow, increasing output flow speed, reducing output flow speed, magnifying the output image on the a display, shrinking the output image on a display, and highlighting at least a portion of output on a display.

19. The computer-readable media of claim 12, wherein the the output is text displayed on a display device.

20. The computer-readable media of claim 12, wherein the output is text read aloud via a speaker.

21. A method of processing an image, comprising the steps of:
monitoring the field of view (FOV) of an image capturing unit for at least one event;
capturing an image upon detection of an event;
processing said image into a user consumable format; and
outputting at least a part of the processed image.

22. The method of claim 21, further comprising extracting text from a captured image and converting the text into a computer readable format.

23. The method of claim 21, wherein an event is one of at least one marker being obscured from the view of the image capturing unit, and the appearance of the at least one marker within the FOV of said image capturing unit.

24. The method of claim 21, further comprising capturing an image upon (1) a detection of a marker becoming obscured from the view of the image capturing unit and (2) a subsequent detection of the absence of motion in the FOV of the image capturing unit above a preset limit of motion level for a preset time span.

25. The method of claim 21, wherein an event is a hand gesture of the user within the FOV of the image capturing unit.

26. The method of claim 25, wherein different hand gestures cause a computer to execute different commands.

27. The method of claim 26, wherein the different command are chosen from the group comprising capturing an image, stopping output flow, starting output flow, rewinding output flow, fast forwarding output flow, pausing output flow, increasing output flow speed, reducing output flow speed, magnifying the output image on the a display, shrinking the output image on a display, and highlighting at least a portion of output on a display.

28. The method of claim 21, wherein the user consumable format is text displayed on a display device.

29. The method of claim 21, wherein the user consumable format is text read aloud via a speaker.

30. A system for processing an image, comprising:
a processor within a housing;
an image capturing unit in communication with the processor;
an inspection surface positioned so that at least a portion of the inspection surface is within a field of view (FOV) of the image capturing unit, wherein an upper surface of the housing is the inspection surface;
software executing on the processor, wherein the software monitors the FOV of the image capturing unit for at least one event and recognizes text in a captured image and converts the text into a computer readable format using OCR (optical character recognition); and
an output device in communication with the processor.
